(19) United States
(12) Patent Application Publication
(10) Pub. No.: US 2009/0192670 A1
(43) Pub. Date: Jul. 30, 2009

(54) Control apparatus and control method for onboard device

(75) Inventors: Tetsuya Hara, Okazaki-city (JP); Kousuke Hara, Hachioji-city (JP); Yoshiaki Sakakura, Yokohama-city (JP); Hirotoshi Iwasaki, Kawasaki-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/320,209

(22) Filed: Jan. 21, 2009

(30) Foreign Application Priority Data
Jan. 25, 2008 (JP) 2008-14755

(51) Int. Cl. G06F 19/00

(52) U.S. Cl. 701/36

(57) ABSTRACT

A control apparatus includes a recommended operation determination section, a user interface section, and a control section. The recommended operation determination section uses a first probability model to determine a second operation associated with a first operation having been performed for an onboard device. The user interface section displays the second operation for an occupant and is supplied from the occupant with a response operation indicating whether to accept or reject the second operation. The control section performs the second operation on an onboard device when a response operation to accept the second operation is supplied via the user interface section.

### CROSS REFERENCE TO RELATED APPLICATION

This application is based on and incorporates herein by reference Japanese Patent Application No. 2008-14755 filed on Jan. 25, 2008.

### FIELD OF THE INVENTION

The present invention relates to a control apparatus and a control method for an onboard device and more particularly to a control apparatus and a control method for recommending operations of an onboard device according to a specified condition.

### BACKGROUND OF THE INVENTION

Patent Document 1: JP-2000-127869 A

Conventional technologies have developed various control apparatuses so as to reduce the burden of a driver who operates an onboard device. For example, the control apparatus automatically controls an onboard device based on information about a vehicle or conditions around the vehicle, such as a light control system and an adaptive cruise control system. Such automatic control apparatus automatically adjusts a specific onboard device to an appropriate setting without requiring the driver to do any operation. However, an automatically adjusted setting may differ from a setting the driver considers to be appropriate. When the automatically adjusted setting differs from the driver's preference, the driver may need to manually re-adjust the setting of the onboard device. The automatic control apparatus, when used, may thus not reduce the operational burden.

The automatic control system described in Patent Document 1 notifies a driver of the onboard device setting to be changed before changing it. The automatic control system actually changes the setting when the driver accepts the setting change. The automatic control system can thus prevent the onboard device from being adjusted to a setting against the driver's intention.

The automatic control system described in Patent Document 1 automatically controls multiple predetermined automatic control items in accordance with an operation mode that prompts the driver to automatically controls the items in batch or, alternatively, confirm the items one by one. When the automatic control system automatically controls the predetermined items in batch, the resulting setting may be inappropriate for the driver depending on the driver's preference or the situation of performing the automatic control. In contrast, when the predetermined items are too many, the driver may be considerably burdened with an operation for determining whether or not to perform the automatic control on each of the items. When the predetermined items are too few, automatically controlling all the items may not provide the driver with an appropriate setting. As a result, the driver may need to manually operate the onboard device.

### SUMMARY OF THE INVENTION

The object of the present invention is to provide a control apparatus and a control method capable of reducing a burden on a driver with operations of onboard devices.

As an example of the present invention, a control apparatus for onboard devices in a vehicle is provided as follows. A recommended operation determination section is configured to use a first probability model to determine a second operation associated with a first operation, which has been performed for an onboard device. A user interface section is configured to display the second operation for an occupant and be supplied from the occupant with a response operation indicating whether to accept or reject the second operation. A control section is configured to perform the second operation on the onboard device when a response operation to accept the second operation is supplied via the user interface section.

According to another example of the present invention, a method is provided for controlling onboard devices. The method comprises: determining, by using a first probability model, a second operation on an onboard device, the second operation being associated with a first operation, the first operation having been performed for an onboard device; displaying the second operation for an occupant in a user interface section; receiving, from the occupant, a response operation indicating whether to accept or reject the second operation via the user interface section; and performing the second operation on the onboard device when a response operation to accept the second operation is supplied via the user interface section.

### BRIEF DESCRIPTION OF THE DRAWINGS

The above and other objects, features, and advantages of the present invention will become more apparent from the following detailed description made with reference to the accompanying drawings. In the drawings:

FIG. 1 is an overall configuration diagram of a vehicle control system including a control apparatus according to an embodiment of the present invention;

FIG. 2 shows an example probability model used as an always proposed model;

FIG. 3 shows an example probability model used as a normally proposed model;

FIG. 4 shows an example probability model used as a response model;

FIG. 5 shows another example probability model used as a response model;

FIG. 6 is a flow chart showing a process of determining and performing a recommended operation;

FIG. 7A shows an example display screen presenting a normally proposed mode;

FIG. 7B shows an example display screen presenting a recommended operation other than the normally proposed mode;

FIG. 8A shows an example display screen displaying a currently selected recommended operation;

FIGS. 8B and 8C show an example display screen displaying an updated recommended operation;

FIG. 9 is a flow chart showing a learning procedure for a probability model;

FIG. 10 is a diagram illustrating a list of example operations recommended by the control apparatus according to the embodiment of the present invention;

FIG. 11 is a diagram illustrating another list of example operations recommended by the control apparatus according to the embodiment of the present invention; and

FIG. 12 is a diagram illustrating a list of sensor information available on the control apparatus according to the embodiment of the present invention for determining recommended operations.

### DETAILED DESCRIPTION OF THE PREFERRED EMBODIMENTS

The following describes a control apparatus for onboard devices according to an embodiment of the present invention.

The control apparatus for onboard devices in a subject vehicle according to an embodiment of the present invention automatically determines theoretically appropriate settings for onboard devices based on information about a vehicle itself or information about conditions around the vehicle. The control apparatus presents (i.e., proposes) an operation for the setting to a driver. When the driver accepts the operation (i.e., the proposal of the operation), the control apparatus automatically controls the onboard device according to the setting. Based on a driver's response to the presented operation, the control apparatus automatically determines an operation, which is related to another onboard device setting item and is supposed to be performed by the driver in association with the presented operation. The control apparatus again presents (i.e., proposes) the anew determined operation to the driver. Based on only the driver's acceptance operation, the control apparatus can control the relevant onboard device in accordance with the anew presented operation, reducing a burden on driver operations.

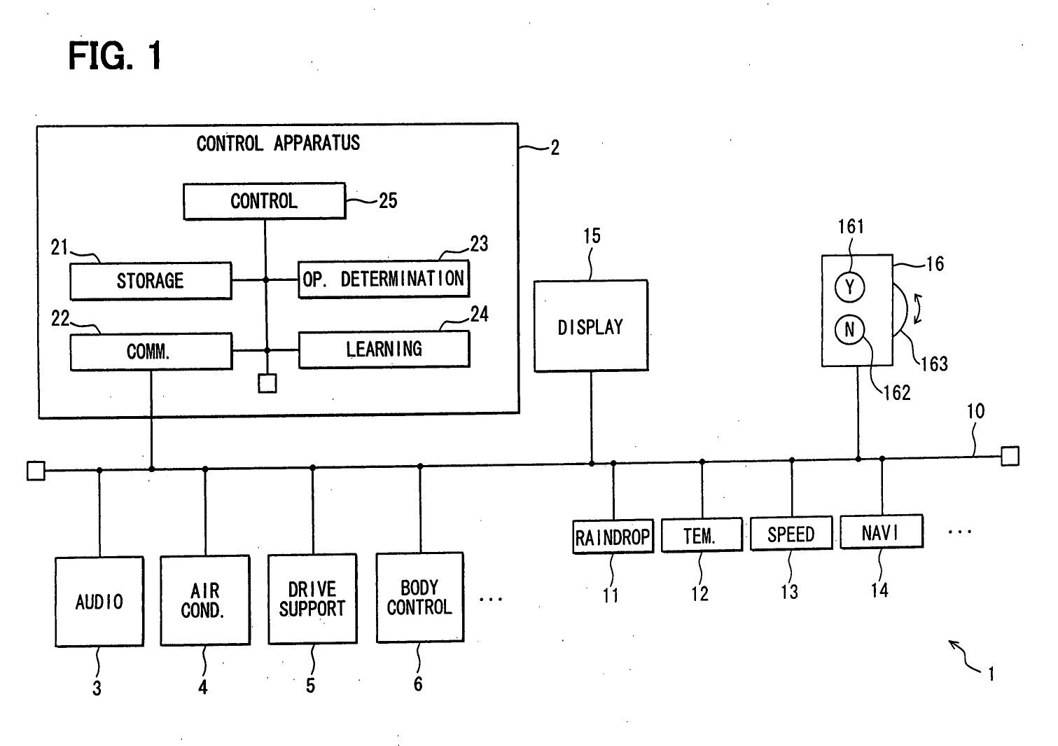

FIG. 1 shows an overall configuration of a vehicle control system 1 including the control apparatus according to the embodiment of the present invention. As shown in FIG. 1, the vehicle control system 1, which is mounted in a subject vehicle, includes multiple onboard devices and a control apparatus 2 for controlling them. The onboard devices include an audio system 3, an air conditioner 4, a driving support apparatus 5 such as an adaptive cruise control (ACC) system, and a body control apparatus 6 for vehicle body parts such as a wiper and a power window. Controller Area Network (CAN) connects the onboard devices with the control apparatus 2. The control apparatus 2 transmits control signals to the onboard devices via the CAN 10 to control the onboard devices. The control apparatus 2 acquires various information from the onboard devices via the CAN 10. For example, the information includes current state information representing current settings of the onboard devices and operation information representing an operation performed by the driver.

The CAN 10 also connects with multiple sensors such as a raindrop sensor 11, a vehicle interior temperature sensor 12, and a vehicle speed sensor 13. A navigation system 14 is also connected with the CAN 10 and functions as a sensor to acquire position information about the vehicle. The control apparatus 2 can acquire information about the vehicle or conditions around the vehicle from the sensors via the CAN 10.

The vehicle control system 1 also includes a display 15 and a simplified input interface 16 that are also connected with the control apparatus 2 via the CAN 10. The display 15 and the simplified input interface 16 provide a user interface section for the driver. For example, the display 15 includes a liquid crystal display or an organic EL display and is placed in an instrument panel. The display 15 may be mounted independently of the instrument panel and may be replaced by a display of another device such as the navigation system 14. The simplified input interface 16 includes a YES button switch 161, a NO button switch 162, and a dial switch 163. The YES button switch 161 performs an acceptance operation in response to the operation presented from the control apparatus 2. The NO button switch 162 performs a rejection operation against the presented operation. The dial switch 163 selects one of the presented operations. For example, the simplified input interface 16 is attached to a steering wheel so that the driver can operate the simplified input interface 16 without releasing his or her hand from the steering wheel. The simplified input interface 16 just needs to be a means capable of acceptance, rejection, and selection operations in response to a content presented from the control apparatus 2 and is not limited to the button switch 161 or 162 or the dial switch 163. For example, the simplified input interface 16 may be configured as an input device such as a lever, slide switch, or encoder. Such input device can be provided for the steering wheel, instrument panel, or center console. The simplified input interface 16 may be also configured as a software switch including a display and a touch panel. Such input device can be provided for an air conditioner panel or a display of the navigation system.

The control apparatus 2 includes one or more microcomputers (not shown) provided with a CPU, ROM, and RAM, peripheral circuits, a storage section 21, and a communication section 22. The storage section 21 uses electrically rewritable nonvolatile memory. The communication section 22 uses a communication interface that communicates with the sensors and onboard devices via the CAN 10. The storage section 21 stores various programs for controlling the control apparatus 2, parameters, and a reference table that shows correspondence relation between an operation identification number indicating the operation type, an onboard device to be operated, a setup item, and a target value.

The control apparatus 2 further includes a recommended operation determination section 23, a learning section 24, and a control section 25 as function modules implemented by the microcomputer and a computer program executed on the microcomputer.

Each onboard device such as the audio system 3 has setup items to be selected such as a volume and a device to be used such as a CD player, radio set, or tape recorder, for example. The recommended operation determination section 23 can determine settings assumed to be appropriate for the driver correspondingly to each setup item. There may be a setup item whose setting differs from the currently assumed settings. The recommended operation determination section 23 can present the driver with an operation for adjusting the current setting of the setup item to the assumed proper setting as a recommended operation.

The recommended operation determination section 23 determines the recommended operation using the following multiple probability models.

(1) A first probability model is an always proposed model. The always proposed model determines an operation to be directly performed on each onboard device based on information acquired by the control apparatus 2 from the sensors.

(2) A second probability model is a normally proposed model. The normally proposed model recommends related operations in batch when information acquired by the control apparatus 2 from each sensor satisfies a specified condition.

(3) A third probability model is a response model. The response model determines a related recommended operation in response to execution of the recommended operation or the driver's direction operation on the onboard device.

When the normally proposed model is activated, the recommended operation determination section 23 presents a recommended operation determined based on the normally proposed model. When the normally proposed model is inactive, the recommended operation determination section 23 selects one or more recommended operations considered optimal out of those determined based on the always proposed model or the response model. The recommended operation determination section 23 then always presents the driver with the selected recommended operations.

The probability models output probabilities of performing specified operations for setup items corresponding to each onboard device. The embodiment uses Bayesian network as a probability model. The Bayesian network models probabilistic cause-effect relationship between events. The Bayesian network finds propagation between nodes using a conditioned probability and is represented by a noncyclic directed graph. Details of the Bayesian network are described in the following publications, to which the present application is cross referenced.

Motomura, Y.; Iwasaki, H. “Bayesian network technology,” Tokyo Denki University Press, first ed., 2006

Shigemasu, K et al., “Bayesian network overview,” Baifukan Co., Ltd., first ed., 2006.

Onoue, M., “Pattern recognition,” Advanced Communication Media Co., Ltd., first ed., 2001.

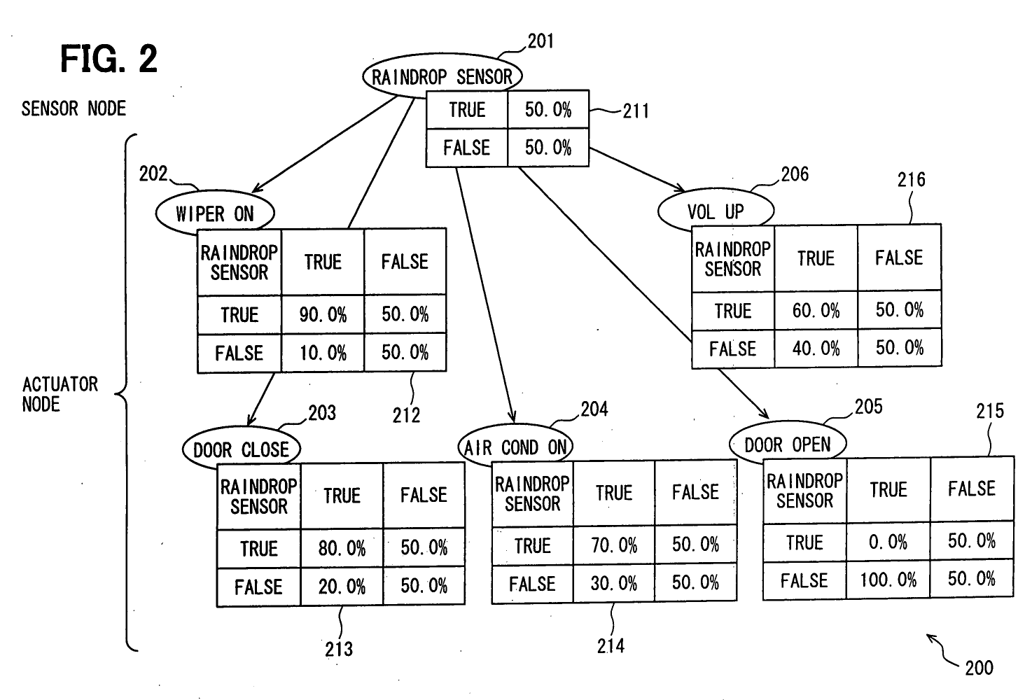

The following describes a process of determining recommended operations in the always proposed model with reference to examples. FIG. 2 shows an example probability model used as the always proposed model. A probability model 200 is equivalent to a 2-layer Bayesian network that includes one sensor node 201 and five actuator nodes 202 through 206. When the raindrop sensor 11 detects a raindrop, the sensor node 201 is supplied with this detection result as an observation event. The sensor node 201 outputs the probability of generating a value to be observed in the observation event, that is, the probability of detecting a raindrop (true) or not detecting a raindrop (false) according to the embodiment. The actuator nodes 202 through 206 are supplied with the probability output from the sensor node 201 and output probabilities of performing specified operations corresponding to the onboard devices, that is, the probability of turning on the wiper, the probability of closing the power window, the probability of turning on the air conditioner 4, the probability of opening the power window, and the probability of increasing the sound volume of the audio system 3.

The sensor node 201 is associated with a forecast probability table 211 concerning the raindrop detection result. The example in FIG. 2 shows the forecast probability of detecting a raindrop (true) and the forecast probability of not detecting a raindrop (false) assumed to be 50% each. When the raindrop detection result is unknown due to a failure of the raindrop sensor 11, for example, the sensor node 201 references the forecast probability table 211 and outputs values such as true=0.5 and false=0.5. When receiving the raindrop detection result from the raindrop sensor 11, the sensor node 201 outputs a probability value corresponding to the detection result. When the raindrop is detected, for example, the sensor node 201 outputs true=1 and false=0. When no raindrop is detected, the sensor node 201 outputs true=0 and false=1.

The actuator nodes 202 through 206 are associated with conditioned probability tables (CPTs) 212 through 216. The CPT defines a conditioned probability of performing a specified operation corresponding to the input probability. The actuator nodes 202 through 206 reference the CPTs 212 through 216. Each actuator node finds a conditioned probability of performing the specified operation for the case of detecting a raindrop and the case of not detecting the same and outputs the probability of performing the specified operation.

Each CPT horizontally corresponds to detecting a raindrop (true) and no raindrop (false) from the left. The CPT vertically corresponds to the probability of performing the operation corresponding to the actuator node (true) and the probability of not performing the same (false) from the top. When the actuator node 202 detects a raindrop, for example, the CPT 212 shows the 90% conditioned probability of turning on the wiper.

The following describes an example of calculating the probability for the actuator node 202 to operate the wiper. The CPT 212 shows the 90% conditioned probability of operating the wiper (true) and the 10% conditioned probability of not operating the wiper (false) corresponding to the detection of raindrop (true). The CPT 212 shows the 50% conditioned probability of operating the wiper (true) and the 50% conditioned probability of not operating the wiper (false) corresponding to the detection of no raindrop (false). Let us suppose that the actuator node 202 receives the probability values of true=1 and false=0 from the sensor node 201 corresponding to the detection of raindrop. The actuator node 202 outputs probability 0.9 of operating the wiper. Let us suppose that the actuator node 202 receives the probability values of true=0 and false=1 from the sensor node 201 corresponding to the detection of no raindrop. The actuator node 202 outputs probability 0.5 of operating the wiper. Let us suppose that the actuator node 202 receives the probability values of true=0.5 and false=0.5 from the sensor node 201 corresponding to the unknown detection of raindrop. The actuator node 202 outputs probability 0.7 (=0.9·0.5+0.5·0.5) of operating the wiper.

The recommended operation determination section 23 maintains always proposed models including not only the above-mentioned probability models but also the other probability models corresponding to information acquired from the sensors such as vehicle interior temperature, vehicle speed, and current vehicle position. An example of the other probability models is supplied with an observed vehicle interior temperature and outputs a probability of changing the setup temperature, air volume, and wind direction or blow for the air conditioner 4. Another example of the other probability models is supplied with the current vehicle position and outputs a probability of changing the sound volume of the audio system 3, opening or closing the power window, or switching between recirculation mode and ambient air mode of the air conditioner 3.

The recommended operation determination section 23 uses the probability models to find probabilities of performing specified operations on the onboard devices in association with the acquired information. The recommended operation determination section 23 stores the acquired probability in the storage section 21 in association with an operation identification number that indicates the corresponding operation.

The normally proposed model will be described. The normally proposed model is supplied with the information as an input value from each sensor and finds a probability of proposing a specified operation to the driver corresponding to the input value. The normally proposed model uses the proposed probability as input and outputs a probability of performing the specified operation.

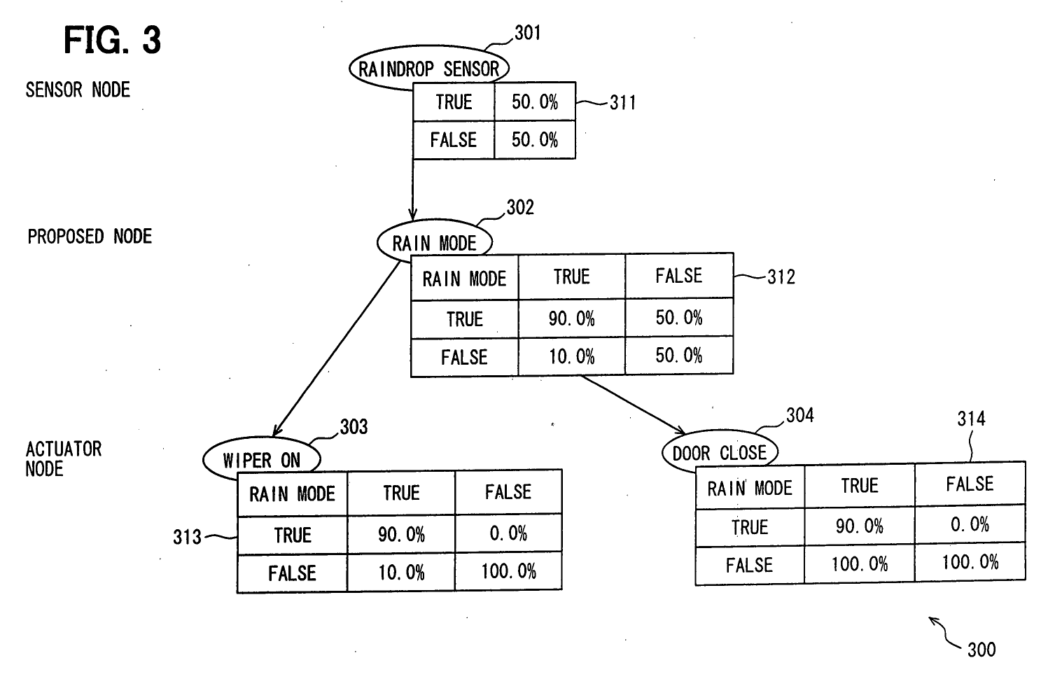

FIG. 3 shows an example probability model used as the normally proposed model. A probability model 300 in FIG. 3 is a 3-layer Bayesian network including one sensor node 301, one proposed node 302, and two actuator nodes 303 and 304. The sensor node 301 is supplied with an observation event or information acquired by any of the sensors. This information is exemplified by a raindrop detection result acquired from the raindrop sensor 11 according to the probability model 300. The sensor node 301 outputs a probability of generating a value to be observed in the observation event. The probability is equivalent to the detection of raindrop (true) or no raindrop (false) according to the probability model 300. The proposed node 302 is supplied with the probability output from the sensor node 301. The proposed node 302 outputs a probability of proposing a normally proposed mode associated with the probability model to the driver. The normally proposed mode denotes rain mode according to the embodiment. The actuator nodes 303 and 304 are supplied with the probability output from the proposed node 302 and output probabilities of performing specified operations on the corresponding onboard devices. In the embodiment, the actuator nodes 303 and 304 output a probability of turning on the wiper and a probability of closing the power window.

The sensor node 301 is associated with a forecast probability table 311 of raindrop detection results. The example in FIG. 3 shows the forecast probability of detecting raindrop (true) and the forecast probability of detecting no raindrop (false) assumed to be 50% each. An output value from the sensor node 301 is found similarly to an output value from the sensor node 201 for the always proposed model as mentioned above.

The proposed node 302 is associated with a CPT 312 that defines conditioned probabilities of proposing the rain mode to the driver in accordance with the input probability. The proposed node 302 references the CPT 312 and finds conditioned probabilities of proposing the rain mode for each of the cases where a raindrop is detected and no raindrop is detected. The proposed node 302 then outputs a probability of activating the rain mode.

The CPT 312 horizontally corresponds to detecting a raindrop (true) and no raindrop (false) from the left. The CPT 312 vertically corresponds to the probability of activating the rain mode (true) and the probability of inactivating the same (false) from the top. When a raindrop is detected, for example, the CPT 312 shows the 90% conditioned probability of activating the rain mode.

Output probabilities from the proposed node 302 can be calculated in the same manner as output probabilities from the actuator nodes 202 through 206 in the always proposed model. The recommended operation determination section 23 may use the operation state of the wiper and the open/close state of the power window as observation events. The recommended operation determination section 23 may calculate back the probability, which activates the rain mode and is inputted to the actuator nodes 303 and 304. The recommended operation determination section 23 may use the calculated probability as well as the output value from the sensor node 301. For example, the belief propagation may be used to calculate a probability output from the proposed node 302.

The actuator nodes 303 and 304 are respectively associated with the CPTs 313 and 314 that define conditioned probabilities of performing a specified operation in accordance with the input probability. Each CPT horizontally corresponds to accepting the rain mode activation (true) and rejecting the same (false) from the left. The CPT vertically corresponds to the probability of performing the operation corresponding to the actuator node (true) and the probability of not performing the same (false) from the top. When the rain mode activation is accepted, for example, the CPT 313 shows that the actuator node 303 turns on the wiper at the conditioned probability of 90%. When the probability of activating the rain mode is greater than or equal to threshold value Th1 (e.g., 0.8), the actuator nodes 303 and 304 are supplied with the probabilities of activating and deactivating the rain mode output from the proposed node 302. The actuator nodes 303 and 304 reference the CPTs 313 and 314 and output probabilities of turning on the wiper and closing the power window. Output probabilities from the actuator nodes 303 and 304 can be calculated in the same manner as those from the actuator nodes 202 through 206 in the always proposed model as mentioned above.

Each actuator node calculates a probability of performing a specified operation. When the calculated probability is greater than or equal to Th2 (e.g., 0.7), the recommended operation determination section 23 selects the specified operation corresponding to the actuator node as a recommended operation. When the selected operation is already performed, the recommended operation determination section 23 does not select that operation. When the power window is already closed, for example, the recommended operation determination section 23 does not recommend the operation of closing the power window. The same holds true even when the actuator node 304 shows the probability of closing the power window and the probability is set to threshold value Th2 or higher.

When at least one recommended operation is available, the recommended operation determination section 23 uses the display 15 to inquire the driver whether or not to activate the rain mode. A mode activation flag F indicates that the rain mode is being recommended or proposed. The recommended operation determination section 23 sets the mode activation flag F to a value such as 1 indicating that the mode is being proposed. The driver may press the YES button switch 161 of the simplified input interface 16 to perform an acceptance operation. At this time, the recommended operation determination section 23 activates the rain mode. The recommended operation determination section 23 notifies the control section 25 of the operation identification number corresponding to the operation recommended for the rain mode. The control section 25 specifies an onboard device to be operated, setup items, and target values based on the notified operation identification number. The control section 25 transmits a control signal to the specified onboard device via the communication section 22 and the CAN 10 so that the value for the specified setup item reaches the target value. The specified onboard device is controlled in this manner.

The driver may press the NO button switch 162 of the simplified input interface 16 to perform a rejection operation. At this time, the recommended operation determination section 23 does not activate the rain mode. Neither the YES button switch 161 nor the NO button switch 162 may be pressed upon expiration of the specified time period such as 60 seconds after the mode is proposed by displaying an indication to activate the mode on the display 15. In such case, the recommended operation determination section 23 may determine that the rain mode activation is rejected.

The driver may perform the acceptance operation or the rejection operation in response to the recommendation to activate the rain mode. The recommended operation determination section 23 then resets the mode activation flag F to a value such as 0 indicating that the rain mode is not being recommended. The recommended operation determination section 23 also does the same when neither the YES button switch 161 nor the NO button switch 162 is pressed for the specified time period as mentioned above.

The recommended operation determination section 23 provides the normally proposed models including not only the above-mentioned probability models but also the other probability models corresponding to information acquired from the sensors such as vehicle interior temperature, vehicle speed, and current vehicle position. For example, the recommended operation determination section 23 may be provided with a probability model as another normally proposed model that finds a probability of activating a specified normally proposed model called a severe heat mode, for example, using an observed vehicle interior temperature as input. Based on the probability of activating that mode, the probability model may output a probability of changing settings of the temperature, air volume, and wind direction for the air conditioner 4. The recommended operation determination section 23 may be provided with a probability model as yet another normally proposed model that finds a probability of activating a specified normally proposed model called a night mode, for example, using the quantity of solar radiation and the current vehicle position as input. Based on the probability of activating the night mode, the probability model may output a probability of turning on the headlight and a probability of decreasing the sound volume of the audio system 3.

The response model will be described. The response model further includes two models. The first response model recommends an operation for complementing a specified operation that is automatically performed upon activation of a specified mode proposed by the normally proposed model. The second response model recommends an operation as follows. The driver may accept a specified operation recommended by the always proposed model. The specified operation may be automatically performed. Alternatively, the driver may manually operate any of the onboard devices. After that, the second response model recommends an operation associated with the automatic or manual operation.

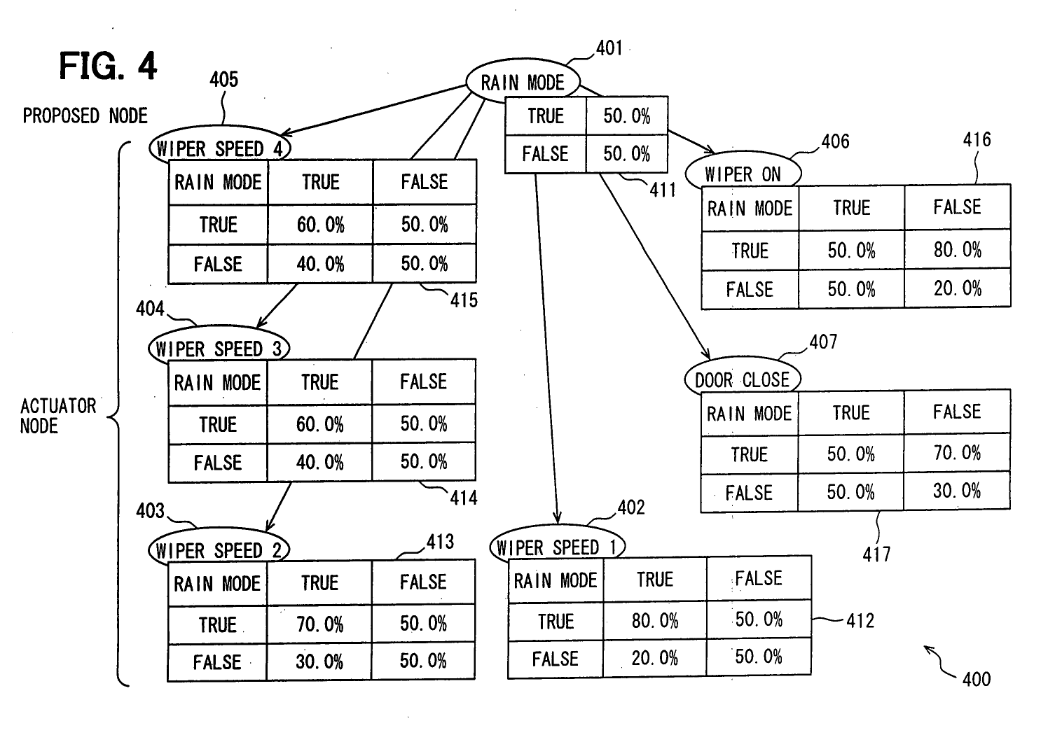

FIG. 4 shows an example probability model used as the first response model. A probability model 400 in FIG. 4 is a 2-layer Bayesian network including one proposed node 401 and six actuator nodes 402 through 407. The probability model 400 is used when the rain mode is proposed. The proposed node 401 is supplied with an observation event that is a driver's operation in response to the recommendation to activate the rain mode. The proposed node 401 outputs a probability of causing a value to be observed in the observation event. For example, the probability model 400 outputs a probability of accepting the rain mode activation (true) and a probability of rejecting the same (false). The actuator nodes 402 through 405 are supplied with the probability output from the proposed node 401 and output probabilities of performing operations for complementing the operation performed in the rain mode. According to the embodiment, the actuator nodes 402 through 405 output probabilities of setting wiper speed values to 1 through 4, respectively. The actuator nodes 406 and 407 are used so as to enable some of operations associated with the rain mode even when the rain mode activation is rejected. The actuator nodes 406 and 407 output probabilities of performing operations associated with the rain mode such as turning on the wiper and closing the power window.

The proposed node 401 is associated with a forecast probability table 411 used when the observation event does not result in acceptance of the rain mode activation. As shown in FIG. 4, the forecast probability table 411 contains the probability of accepting the rain mode activation (true) and the probability of rejecting the same (false) assumed to be 50% each. The actuator nodes 402 through 407 are associated with CPTs 412 through 417 that indicate conditioned probabilities of performing operations corresponding to the acceptance result of rain mode activation. Each CPT horizontally corresponds to accepting the rain mode activation (true) and rejecting the same (false) from the left. The CPT vertically corresponds to the probability of performing the operation corresponding to the actuator node (true) and the probability of not performing the same (false) from the top. When the rain mode activation is accepted, for example, the CPT 412 shows that the actuator node 402 sets the wiper operation speed to ‘1’ at the conditioned probability of 80%.

Each of the actuator nodes 402 through 405 calculates a probability of performing an operation that complements an operation performed upon activation of the rain mode. In this case, the complementary operation specifies the wiper operation speed when the rain mode activation turns on the wiper. For this reason, the CPTs 412 through 415 are configured so as to increase the probability of performing the complementary operation when the rain mode activation is accepted (true). The actuator nodes 406 and 407 calculate probabilities of performing only some of operations associated with the rain mode when the rain mode activation is rejected. For this reason, the CPTs 416 through 417 are configured so as to increase the probabilities of performing only some of operations when the rain mode activation is rejected (false). The first response model may be configured using not only the proposed node but also a sensor node similar to that for the corresponding normally proposed model.

A recommended candidate determination section 23 supplies the probability model 400 with the acceptance result concerning the rain mode activation and finds a probability of performing the operation associated with each of the actuator nodes. A probability output from each actuator node can be calculated in the same manner as that output from the actuator node for the above-mentioned always proposed model. The recommended operation determination section 23 stores the acquired probability in the storage section 21 in association with an operation identification number that indicates the corresponding operation.

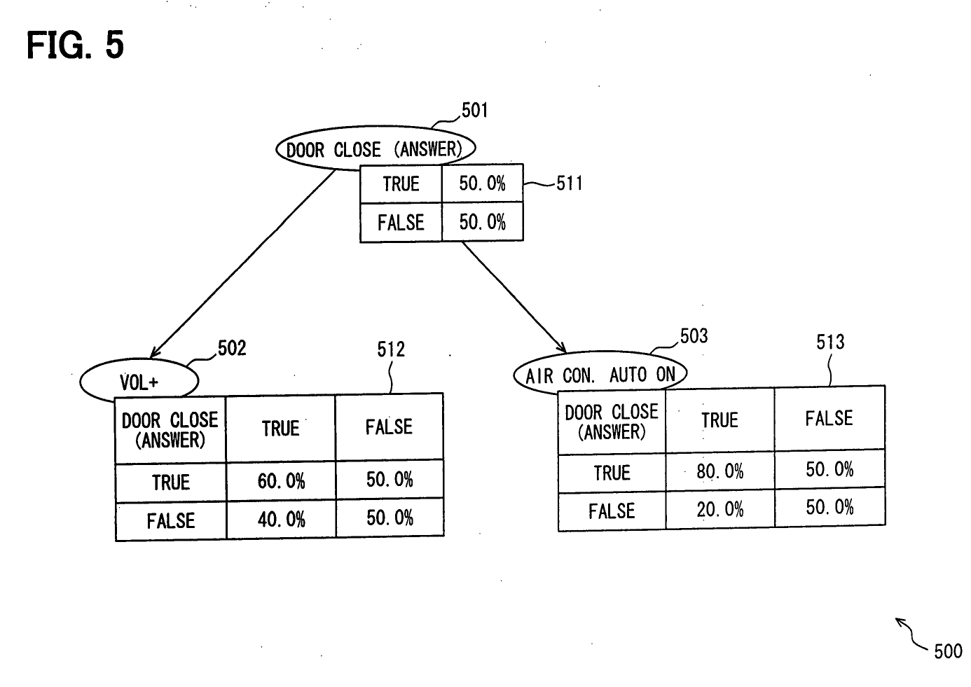

The second response model will be described. FIG. 5 shows an example probability model used as the second response model. A probability model 500 in FIG. 5 is a 2-layer Bayesian network including one control answer node 501 and two actuator nodes 502 and 503. The probability model 500 is used after an operation of closing the power window is performed. The operation is not limited to the case where the driver manually closes the power window. The operation also applies to a case where the recommended operation determination section 23 presents an operation of closing the power window as the recommended operation and the driver accepts the recommended operation.

The control answer node 501 is supplied with an observation event indicating whether or not the operation of closing the power window is performed. The control answer node 501 outputs probabilities of generating values to be observed in the observation event. The probability model 500 outputs the probability of performing an operation of closing the power window (true) and the probability of not performing the same (false). The actuator nodes 502 and 503 are supplied with the probability output from the control answer node 501 and output probabilities of performing operations associated with that operation. According to the embodiment, the actuator nodes 502 and 503 respectively output probabilities of increasing the sound volume of the audio system 3 and automatically operating the air conditioner 4.

The control answer node 501 is associated with a forecast probability table 511 that is used on failure to acquire the observation event indicating whether or not the operation of closing the power window is performed. As shown in FIG. 5, the forecast probability table 511 contains the probability of performing the operation for closing the power window (true) and the probability of not performing the same (false) assumed to be 50% each. The actuator nodes 502 and 503 are associated with the CPTs 512 and 513 indicating conditioned probabilities of performing operations associated with the operation of closing the power window. Each CPT horizontally corresponds to performing the operation of closing the power window (true) and not performing the same (false) from the left. The CPT vertically corresponds to the probability of performing the operation corresponding to the actuator node (true) and the probability of not performing the same (false) from the top. When the operation of closing the power window is performed, for example, the CPT 512 shows that the actuator node 502 performs the operation of increasing the sound volume of the audio system 3 at the conditioned probability of 60%.

The recommended candidate determination section 23 supplies the probability model 500 with a signal indicating whether or not the operation of closing the power window is performed. The recommended candidate determination section 23 then finds a probability of performing an operation associated with each actuator node. A probability output from each actuator node can be calculated in the same manner as the probability output from the actuator node in the above-mentioned always proposed model. The recommended operation determination section 23 stores the calculated probability in the storage section 21 in association with an operation identification number that indicates the corresponding operation.

The first and second response models are hot limited to the above-mentioned examples.

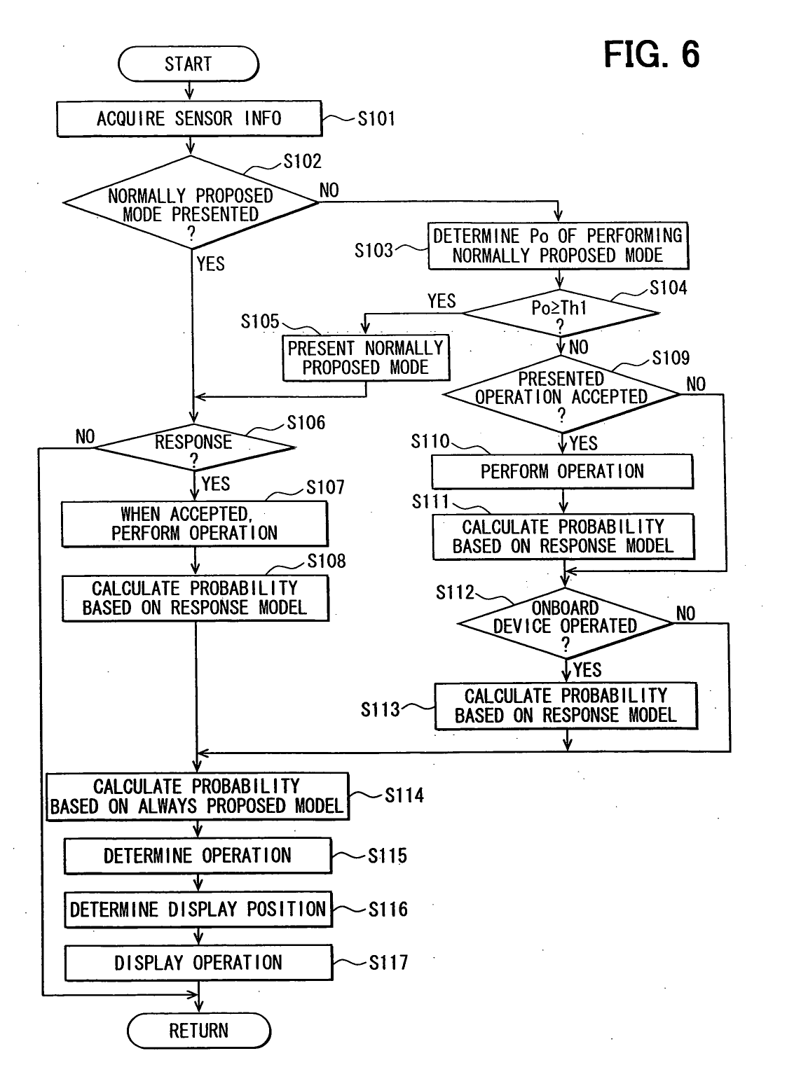

With reference to a flow chart in FIG. 6, the following describes a process of determining and performing the recommended operation. The control section 25 of the control apparatus 2 controls the process described below.

The control apparatus 2 acquires sensor information from the sensors via the CAN 10 (S101). The sensor information includes the information about the vehicle such as the current vehicle position and speed and the information about conditions around the vehicle such as the presence or absence of raindrop and the vehicle interior temperature. The control apparatus 2 then references the mode activation flag and determines whether or not there is presented any normally proposed mode recommended based on the normally proposed model (S102). When no normally proposed mode is presented, the recommended operation determination section 23 of the control apparatus 2 acts on each normally proposed model and determines whether or not there is an operation recommended as a normal proposal. When there is a recommended operation, the recommended operation determination section 23 finds probability P₀ of performing the normally proposed mode corresponding to the normally proposed model (S103). As mentioned above, the recommended operation determination section 23 finds a probability of performing the operation associated with the actuator node included in the normally proposed model. The probability is found as output from the actuator node. When the probability is greater than or equal to the specified threshold value Th2, the recommended operation determination section 23 assumes the operation to be recommended. The recommended operation determination section 23 determines whether or not to present the normally proposed model (S104). When there is an operation to be recommended as the normal proposal and probability P₀ is greater than or equal to specified threshold value Th1, the recommended operation determination section 23 allows the display 15 to present the normally proposed mode (S105). The recommended operation determination section 23 sets the mode activation flag to a value indicating that the normally proposed mode is being presented.

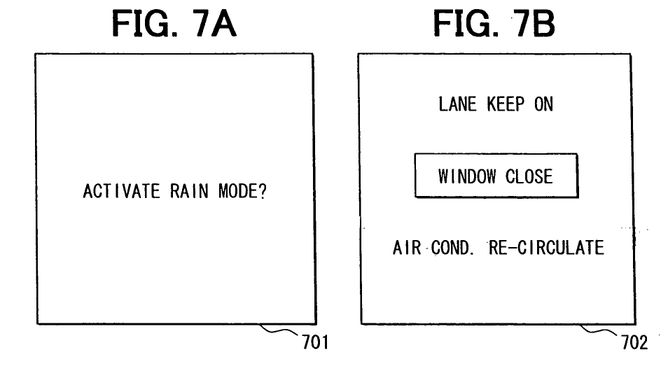

FIG. 7A shows an example screen on the display 15 when the normally proposed mode is presented. As shown in FIG. 7A, a screen 701 on the display 15 displays only text inquiring whether or not to activate the recommended normally proposed mode. The display 15 may further display the content of an operation that is automatically performed as a result of activation of the normally proposed mode.

Control is passed to S106 after S105 or when it is determined at S102 that the normally proposed mode is already presented. At S106, the recommended operation determination section 23 determines whether or not there is a response to the presented normally proposed mode. The response includes not only an operation of accepting the normally proposed mode using the simplified input interface 16 but also an operation of rejecting the normally proposed mode. When the driver operates any of the onboard devices in the duration of the normally proposed mode being presented, the recommended operation determination section 23 determines that an operation to reject the presented normally proposed mode is performed. The recommended operation determination section 23 also does the same when a specified period (e.g., 60 seconds) has passed after initiation of the normally proposed mode. When an operation is performed so as to accept the normally proposed mode, the control section 25 automatically performs the recommended operation associated with the normally proposed mode (S107). The control section 25 acquires an operation identification number from the recommended operation determination section 23. The operation identification number corresponds to the recommended operation associated with the normally proposed mode. The control section 25 references a reference table stored in the storage section 21 and specifies an onboard device to be operated, setup items, and target values based on the operation identification number. The control section 25 transmits a control signal to the specified onboard device via the communication section 22 and the CAN 10 so that the value for the specified setup item reaches the target value. The specified onboard device is controlled in this manner. The recommended operation determination section 23 calculates a probability of performing an operation that complements the operation performed based on the first response model. The recommended operation determination section 23 stores the probability in the storage section 21 in association with the operation identification number indicating the corresponding operation (S108).

At S104, the recommended operation determination section 23 does not present the normally proposed mode when there is no recommended operation associated with the normally proposed mode or probability P₀ of activating the normally proposed mode is smaller than threshold value Th1. In this case, the display 15 presents the driver with a recommended operation determined based on the always proposed model or any of the response models. FIG. 7B shows an example screen displayed on the display 15. As shown in FIG. 7B, a screen 702 of the display 15 lists recommended operations so that the driver can easily view. The driver can select any of the operations by operating the dial switch 163 of the simplified input interface 16.

The recommended operation determination section 23 determines whether or not any of the presented recommended operations is accepted via the simplified input interface 16 (S109). When any of the presented recommended operations is accepted, the control section 25 automatically performs the recommended operation (S110). The control section 25 specifies the recommended operation selected and accepted via the simplified input interface 16. The control section 25 acquires the operation identification number corresponding to the recommended operation from the recommended operation determination section 23. The control section 25 references the reference table and specifies an onboard device to be operated based on the operation identification number. The control section 25 transmits a control signal to the specified onboard device via the communication section 22 and the CAN 10 so that the value for the specified setup item reaches the target value. The specified onboard device is controlled in this manner. The recommended operation determination section 23 calculates a probability of performing an operation associated with the performed operation based on the second response model. The recommended operation determination section 23 stores the probability in the storage section 21 in association with the operation identification number indicating the corresponding operation (S111).

Control passes to S112 after S111 or when it is determined at S109 that none of the recommended operations is accepted. At S112, the recommended operation determination section 23 determines whether or not the driver manually operates any of the onboard devices. Specifically, the recommended operation determination section 23 may receive a signal from an onboard device via the CAN 10. This signal indicates that some setting is changed on the onboard device. In this case, the recommended operation determination section 23 determines that the onboard device is operated manually. When it is determined that some onboard device is manually operated, the recommended operation determination section 23 calculates a probability of performing an operation associated with the performed operation based on the response model. The recommended operation determination section 23 stores the probability in the storage section 21 in association with the operation identification number indicating the corresponding operation (S113).

Control passes to S114 after S108 or S113 or it is determined at S112 that none of the onboard devices is operated manually. At S114, the recommended operation determination section 23 calculates a probability of performing an operation considered optimal from the sensor information acquired at S101 based on the always proposed model. The recommended operation determination section 23 stores the probability in the storage section 21 in association with the operation identification number indicating the corresponding operation.

The recommended operation determination section 23 then determines a recommended operation based on the probability of performing the specified operation (S115). This probability is calculated based on each response model and the always proposed model. The recommended operation determination section 23 uses the following equation to calculate representative probability Pᵢ of performing an operation corresponding to each operation identification number stored in the storage section 21.

Pᵢ=Cs·Psᵢ+Cn·Pnᵢ+Cr·Prᵢ+Ca·Paᵢ (1)

In equation (1), Psᵢ denotes the probability of performing an operation corresponding to operation identification number i (1, 2, . . . , n) and is calculated at S114 based on the always proposed model. Pnᵢ denotes the probability of performing an operation corresponding to operation identification number i and is calculated at S108 based on the first response model associated with the normally proposed model. Prᵢ denotes the probability of performing an operation corresponding to operation identification number i and is calculated at S111 based on the second response model associated with the recommended operation. Paᵢ denotes the probability of performing an operation corresponding to operation identification number i and is calculated at S113 based on the second response model associated with manual operation of the onboard device. Cs, Cn, Cr, and Ca denote weighting coefficients and are set to Cs=0.1, Cn=0.4, Cr=0.3, and Ca=0.2, respectively. The weighting coefficients are configured so that the ratio of Pnᵢ, Prᵢ, and Paᵢ to the representative probability Pᵢ becomes greater than Psᵢ. That is, Pnᵢ, Prᵢ, and Paᵢ are the probabilities that are found concerning driver's operations. Psᵢ is the probability of performing operations and is found based on the sensor information. So configuring the weighting coefficients makes it possible to more easily propose an operation associated with the operation performed by the driver.

When any of Psᵢ, Pnᵢ, Prᵢ, and Paᵢ is not calculated, the recommended operation determination section 23 assumes the corresponding value to be 0 and calculates representative probability Pᵢ. When calculating representative probability Pᵢ for each of the operations, the recommended operation determination section 23 resets representative probability Pᵢ for the operation to 0. The purpose is to prevent the driver from being presented with an actually unchanged operation when the state of the operated onboard device matches the current state. When the power window is closed currently, for example, the recommended operation determination section 23 resets representative probability Pᵢ to 0 concerning the operation of closing the power window.

The recommended operation determination section 23 selects as many recommended operations as an operation count in the descending order of the acquired representative probability Pᵢ. The operation number is 1 or greater and is configured so that the driver does not feel too burdened with selection of recommended operations. The embodiment sets the operation count to 3. Different operations may be requested for the same setup item such as operations of opening the power window and closing the same. The recommended operation determination section 23 may select only one of the operations supplied with a higher probability.

When the recommended operation is determined, the recommended operation determination section 23 determines a position for displaying the recommended operation on the display 15 (S116). The newly recommended operation may completely differ from the previously presented operation. In such case, the recommended operation determination section 23 determines the display position only in consideration for the newly recommended candidate. Any of the newly recommended operations may match the previously presented operation. In such case, the recommended operation determination section 23 determines the display position so as not to change the display position of the matching recommended operation.

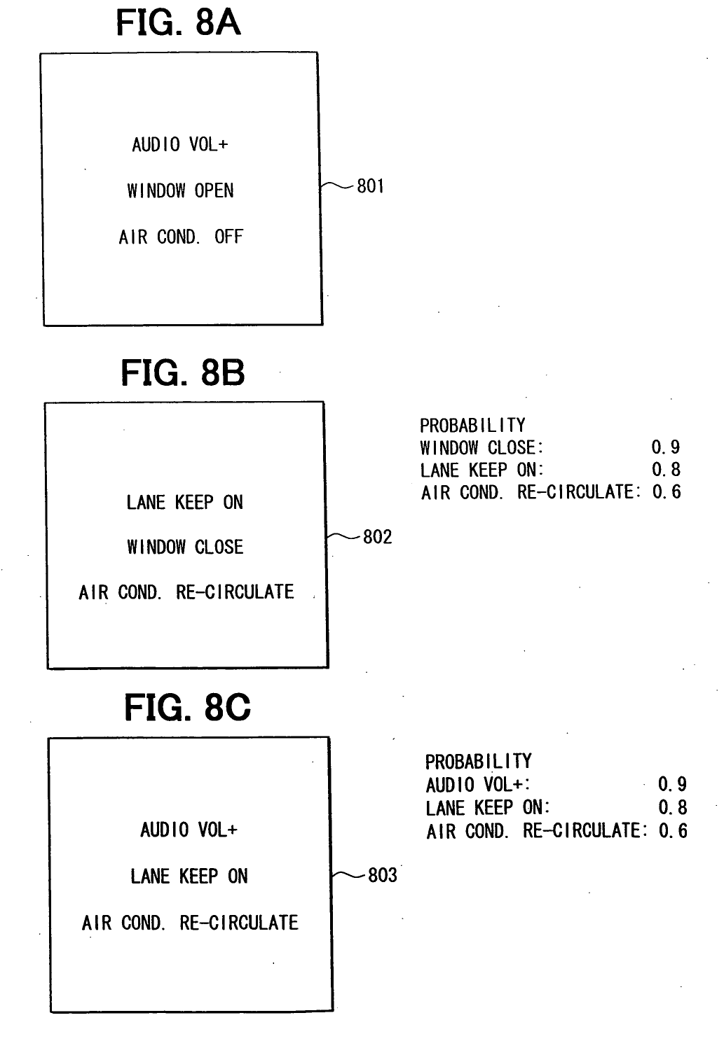

With reference to FIGS. 8A to 8C, the following describes determination of the display position. FIG. 8A shows an example screen on the display 15 that displays the currently selected recommended operation. FIGS. 8B and 8C show example screens on the display 15 that displays recommended operations updated at S115.

In principle, the embodiment displays the recommended operations at the center, top, and bottom of the display 15 in the descending order of representative probabilities corresponding to the recommended operations. On a screen 801 in FIG. 8A, the operation of opening the power window corresponds to the largest representative probability. The operation of increasing the sound volume of the audio system 3 corresponds to the second largest representative probability. The operation of turning off the air conditioner 4 corresponds to the third largest representative probability. Let us suppose that the three recommended operations newly found at S115 correspond to closing the power window, turning on a lane keeping assist system of the driving support apparatus 5, and enabling the recirculation mode of the air conditioner 4 in the descending order of the corresponding representative probabilities. In this case, all the newly found recommended operations differ from the previously presented recommended operations. As shown on a screen 802 in FIG. 8B, the newly found recommended operations are displayed on the display in the defined order. The display 15 shows the operation of closing the power window corresponding to the largest representative probability at the center. The display 15 shows the operation of turning on the lane keeping assist system corresponding to the second largest representative probability at the top. The display 15 shows the operation of enabling the recirculation mode of the air conditioner 4 corresponding to the third largest representative probability at the bottom.

On the other hand, one of the three recommended operations found at S115 may match the previously presented recommended operation. The recommended operation determination section 23 determines display positions of the recommended operations so as not to change the display position of the matching recommended operation on the display 15. As shown in FIG. 8C, for example, let us suppose that the largest representative probability is assigned to the operation of increasing the sound volume of the audio system 3 out of the three newly found recommended operations. The operation of increasing the sound volume is originally displayed at the top of the display 15 as shown on the screen 801 in FIG. 8A and the screen 803 in FIG. 8C. The newly found recommended operation of increasing the sound volume is also displayed at the top of the display 15. The two remaining recommended operations differ from the previously presented ones and are displayed at the center and bottom of the display 15 in the descending order of representative probabilities according to the rule.

After determining the display positions of the recommended operations, the recommended operation determination section 23 displays the recommended operations on the display 15 (S117). The recommended operation determination section 23 associates the display position of the recommended operation on the display 15 with the operation identification number indicating that recommended operation. The purpose is to allow the simplified input interface 16 to determine which recommended operation is selected. The control apparatus 2 then terminates the process. The control apparatus 2 periodically repeats the process at S101 through S117 at intervals often seconds or one minute, for example. Alternatively, the control apparatus 2 may perform the process at S101 through S117 when a substantial change is detected in any of the sensor information. To explain the substantial change in the sensor information, a given probability model uses ranges of sensor information values as a basis for calculating a probability output from the sensor node. When the sensor node is supplied with a sensor information value belonging to a given range, the value may change to belong to a different range. This signifies the substantial change in the sensor information. For example, let us suppose that the sensor node is supplied with vehicle interior temperatures and outputs probabilities of vehicle interior temperatures in the range of 20° C. to 25° C. and the range of 26° C. to 30° C. When the vehicle interior temperature changes from 21° C. to 24° C., both temperatures belong to the range of 20° C. to 25° C. The vehicle interior temperature is assumed not to change substantially. When the vehicle interior temperature changes from 24° C. to 26° C., the changed vehicle interior temperature belongs to the different range. The vehicle interior temperature is assumed to change substantially.

The learning section 24 modifies any of the above-mentioned probability models when the driver manually operates the onboard device. As mentioned above, the embodiment may use multiple probability models such as the normally proposed model, the always proposed model, and the response model for operations concerning one setup item of the onboard device. The learning section 24 specifies the probability model to be learnt based on the vehicle position information when the driver operates the onboard device. To do this, the learning section 24 periodically acquires the vehicle position information from the navigation system 14. The learning section 24 stores the vehicle position information in the storage section 21 when the driver uses the simplified input interface 16 to perform the acceptance operation or the recommended operation. The vehicle position at this time is hereafter referred to as a responded position. When the driver operates a given onboard device similarly, the learning section 24 allows the storage section 21 to store the operated onboard device and the setup item in association with the sensor information including the vehicle position information acquired from the sensors during the operation. The vehicle position at this time is hereafter referred to as an operated position. The learning section 24 also allows the storage section 21 to store the vehicle position at the time of presenting the driver with the normally proposed model in association with the normally proposed model. The vehicle position at this time is hereafter referred to as a normally proposed position. The learning section 24 determines which probability model to be learnt based on differences between the responded position, the operated position, and the normally proposed position. After determining the probability model to be learnt, the learning section 24 learns the probability model so as to increase the probability of recommending the operation performed by the driver.

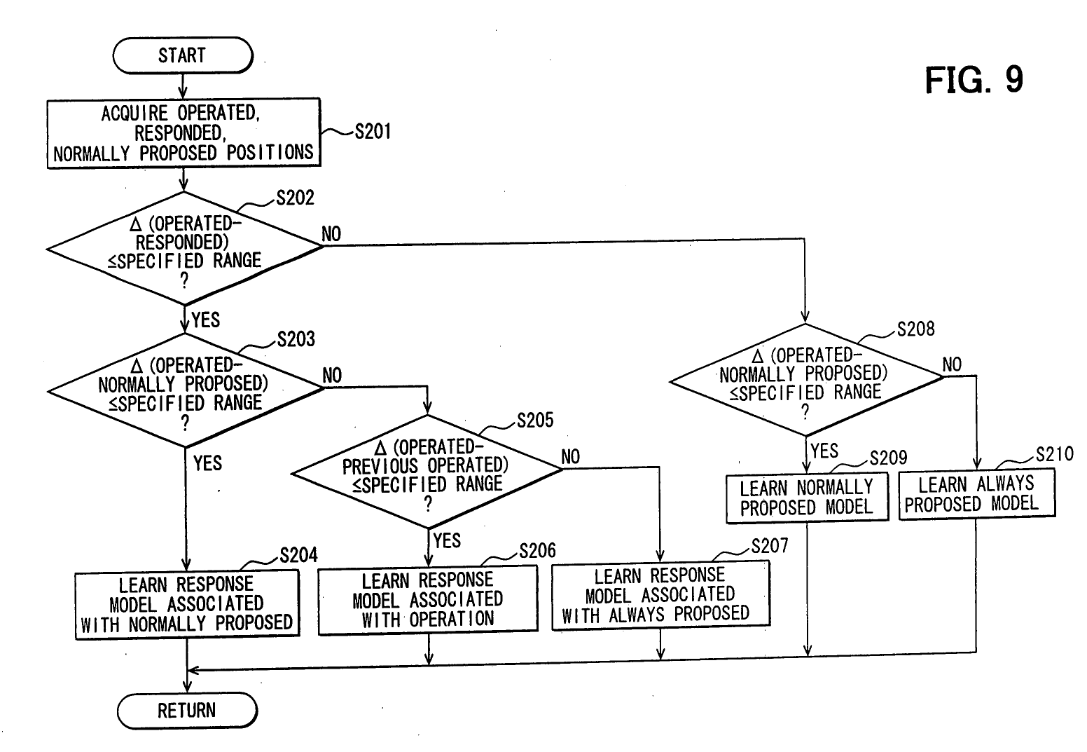

FIG. 9 is a flow chart showing a process in which the learning section 24 learns the probability model.

The learning section 24 acquires the vehicle position information from the navigation system 14 and acquires the operated position, the responded position, and the normally proposed position in association with driver operations (S201). The learning section 24 then determines whether or not a specified range contains the most recent difference between the most recent operated position and the responded position (S202). The specified range may be defined as 500 m or 1 km, for example, so that the situation around the vehicle does not change substantially.

When the specified range contains the difference between the operated position and the responded position at S202, the learning section 24 determines whether or not a specified range contains a difference between the operated position and the normally proposed position (S203). The specified range may be the same as or wider than that at S202. When the specified range contains the difference between the operated position and the normally proposed position, it is assumed that the normally proposed model is activated and the subsequently proposed operation is inappropriate for the driver. The learning section 24 then learns a response model for determining an operation to be recommended after activation of the normally proposed model. At this time, the learning section 24 references the types of normally proposed models stored in the storage section 21 in association with normally proposed positions and determines which response model to learn. The response model to be learnt includes actuator nodes, one of which relates to the setup item of the onboard device operated by the driver. The actuator node is associated with the CPT that is stored in association with the operated position. The learning section 24 modifies this CPT so as to increase the probability of recommending the operation performed by the driver. For example, let us suppose that the probability model 400 in FIG. 4 is to be learnt and the driver sets the wiper speed to 4. With reference to the CPT 415 in the rain mode assumed to be true, the learning section 24 increases the conditioned probability of setting the wiper speed to 4 by 10% from 60% to 70%. By contrast, also in the rain mode assumed to be true, the learning section 24 decreases the conditioned probability of not setting the wiper speed to 4 by 10% from 40% to 30%. The conditioned probability may be unchanged in the rain mode assumed to be false.

The response model to be learnt may not contain the actuator node corresponding to the operation performed by the driver. In such case, the learning section 24 adds an actuator node corresponding to the operation to the response model. For example, let us suppose that the driver turns on the headlight when the probability model in FIG. 4 is to be learnt. The learning section 24 adds an actuator node to the probability model 400 so that the added actuator node relates to the driver's operation of turning on the headlight. A CPT corresponding to the newly added actuator node contains conditioned probabilities whose values are all configured to be equal.

The learning section 24 may not learn the response model when the response model to be learnt does not contain the actuator node corresponding to the operation performed by the driver.

At S203, the specified range may not contain the difference between the operated position and the normally proposed position. The learning section 24 then finds a difference between the operated position and the other operated position corresponding to the previous driver's operation and determines whether or not the difference belongs to the specified range (S205). Like S203, the specified range may be defined so that the situation around the vehicle does not change substantially. When the specified range contains the difference between the operated position and the other operated position corresponding to the previous driver's operation, the learning section 24 assumes the operation recommended for the driver's operation to be inappropriate for the driver. The learning section 24 then learns a response model for determining the recommended operation associated with the driver's operation (S206). At S205, the specified range may not contain the difference between the operated position and the other operated position corresponding to the previous driver's operation. In this case, it is assumed that the driver responds to the always proposed model and the recommended operation presented for the response is inappropriate. The learning section 24 then learns a response model for recommending the operation associated with the operation recommended by the always proposed model (S207).

The response models are learnt at S206 and S207 in the same manner as S204. The response model to be learnt includes an actuator node corresponding to the driver's operation. The learning section 24 modifies the CPT associated with this actuator node so as to increase the probability of recommending the operation performed by the driver. When the response model to be learnt does not include the actuator node corresponding to the driver's operation, the learning section 24 may add an actuator node corresponding to the driver's operation as mentioned above.

At S202, the specified range may not contain the difference between the operated position and the responded position. In this case, the learning section 24 assumes no association between the operation manually performed by the driver on the onboard device at the operated position and the operation performed by the driver using the simplified input interface 16 at the responded position. The learning section 24 finds a difference between the operated position and the most recent normally proposed position and determines whether or not the difference is contained in a specified range (S208). Like S202, the specified range may be defined so that the situation around the vehicle does not change substantially. When the specified range contains the difference between the operated position and the most recent normally proposed position, the learning section 24 learns a normally proposed model associated with the normally proposed model presented at the normally proposed position (S209). When the specified range does not contain the difference between the operated position and the most recent normally proposed position at S208, the learning section 24 learns the always proposed model (S210). At this time, the learning section 24 aims to learn the sensor node supplied with sensor information acquired at the operated position and the always proposed model including the actuator node corresponding to the driver's operation.

The normal proposal or the always proposed model is learnt at S209 and S210 in the same manner as learning of the response model at S204. The probability model to be learnt includes an actuator node corresponding to the driver's operation. The learning section 24 modifies the CPT associated with this actuator node so as to increase the probability of recommending the driver's operation. When the normally proposed model to be learnt does not include the actuator node corresponding to the driver's operation, the learning section 24 may add an actuator node corresponding to the driver's operation to the normally proposed model.

Upon completion of the above-mentioned learning steps, the learning section 24 stores the updated probability model in the storage section 21 and terminates the learning process. The learning section 24 repeats the process at S201 through S210 each time the driver manually operates the onboard device.

As mentioned above, the learning section 24 learns the probability models so as to preferentially recommend the driver's operation. The control apparatus 2 can recommend proper operations according to the driver's preference.

At S202, the learning section 24 uses the difference between the operated position and the responded position as a criterion. Instead, the learning section 24 may determine whether or not a specified period contains a difference between the time (operation time) for the driver to manually perform the onboard device and the time (response time) to perform the acceptance operation or the rejection operation using the simplified input interface 16. When the specified period contains the time difference between the operation time and the response time, control is passed to S203. When the specified period does not contain the time difference, control is passed to S208. Also in this case, the specified period may be defined as 30 seconds or one minute, for example, so that the situation around the vehicle does not change substantially. Also at S203, S205, and S208, the learning section 24 may determine whether or not the specified period contains a time difference between the operation time and the time (normal proposal time) to present the normally proposed model or a time difference between the most recent operation time and the previous operation time. Further, the learning section 24 may learn the probability model used to calculate representative probability Pᵢ of the recommended operation that caused the driver to respond. For example, the above-mentioned equation (1) is used to calculate representative probability Pᵢ. The probabilities Psᵢ, Pnᵢ, Prᵢ, and Paᵢ are calculated based on the always proposed model and the response models. Of these probabilities, Pnᵢ is calculated based on the first response model for determining an operation to be recommended after activation of the normally proposed model and is assumed to be largest. In this case, the learning section 24 determines that the driver's response operation is targeted for the operation recommended by the first response model. The learning section 24 then learns the first response model when the specified range contains the difference between the operated position and the responded position. Furthermore, the learning section 24 may learn multiple probability models when a specified conditions is satisfied. For example, let us suppose that the specified range contains a difference between the operated position and the previous operated position when the first response model is to be learnt. The learning section 24 may further learn a second response model for determining a recommended operation associated with the driver's operation.

As mentioned above, the control apparatus according to the present embodiment for onboard devices can automatically determine an onboard device setting assumed to be optimal based on the information about the vehicle or about situations around the vehicle. The control apparatus can present the driver with a recommended operation associated with the setting. The driver just needs to accept the recommended operation using the simplified input interface. The control apparatus can automatically control the onboard device according to the setting. The control apparatus acts on the driver's response to the presented recommended operation and automatically determines a recommended operation concerning another setup item of the onboard device the driver may operate. The automatically determined recommended operation is associated with the previously presented recommended operation. The control apparatus again presents the driver with the recommended operation and controls the onboard device so that just the driver's acceptance operation enables the setting. The driver can manipulate multiple associated setup items using the simplified input interface. The control apparatus can reduce the burden of driver's operations.

The control apparatus uses the always proposed model to always find a recommended operation. The control apparatus can always present multiple recommended operations. The control apparatus can prevent the driver from being surprised by a sudden display of the recommended operation on the display 15.

The invention is not limited to the above-mentioned embodiments. For example, the recommended operation determination section 23 may find more recommended operations than are displayed on the display 15 at a time. In this case, the recommended operations are displayed from the top to the bottom in the descending order of found representative probabilities. The display 15 may scroll the screen to sequentially display the recommended operations in accordance with the operation of the dial switch 163 on the simplified input interface 16.

The display 15 may display the specified number of recommended operations such as three. The simplified input interface 16 may be provided with selection buttons corresponding to the displayed recommended operations. For example, three selection buttons are used when three recommended operations are displayed. When a given selection button is pressed on the simplified input interface 16, the control apparatus performs the recommended operation corresponding to the selection button. In addition to the selection button, the simplified input interface 16 may be provided with a button switch for the rejection operation similarly to the above-mentioned embodiments.

The representative probability corresponding to a recommended operation may be given a specified value such as 0.9 or larger and may indicate that the driver is highly likely to perform the recommended operation. In such case, the display 15 may display the recommended operation in a larger size or in a different color so as to be marked. The recommended operation determination section 23 may determine a recommended operation based on each onboard device or a combination of onboard devices. The display 15 may display the recommended operation in accordance with each onboard device or the combination of onboard devices. For example, the display 15 may display a recommended operation concerning the air conditioner or the body control apparatus always at the top, a recommended operation concerning the audio system always at the center, and a recommended operation concerning the other onboard devices at the bottom.

Instead of the simplified input interface 16, the vehicle control system 1 may include a microphone connected to the control apparatus 2 and a speech recognition program module running on the microcomputer of the control apparatus 2. In this case, the driver utters the name and the acceptance or rejection of a recommended operation displayed on the display 15. The microphone collects the driver's speech. The speech recognition program module recognizes the speech and determines which recommended operation is accepted or rejected.

According to the above-mentioned embodiments, the driver may accept any of the recommended operations using the simplified input interface 16. The learning section 24 then may learn a probability model associated with the determination of the recommended operation so as to increase the probability of performing the recommended operation. By contrast, the driver may reject any of the recommended operations using the simplified input interface 16. The learning section 24 then may learn a probability model associated with the determination of the recommended operation so as to decrease the probability of performing the recommended operation. For example, let us suppose that the display 15 displays the operation of increasing the sound volume of the audio system 3 as a recommended operation and the driver accepts the recommended operation using the simplified input interface 16. In this case, the learning section 24 modifies a probability model used for the determination of the recommended operation so as to increase the probability of performing the operation for increasing the sound volume of the audio system 3. That is, the probability model can be identified as outputting a non-zero value for any of the probabilities Psᵢ, Pnᵢ, Prᵢ, and Paᵢ in equation (1) used for calculating the representative probability Pᵢ. Similarly to the above-mentioned modification of the probability model, the learning section 24 modifies the probability model by modifying the CPT that is contained in the corresponding probability model and is associated with the actuator node corresponding to the operation for increasing the sound volume of the audio system 3.

Multiple sensor nodes may be included in each of the probability models used for determining the recommended operation and the normally proposed mode. The use of multiple sensor nodes can determine a recommended operation in accordance with detailed conditions.

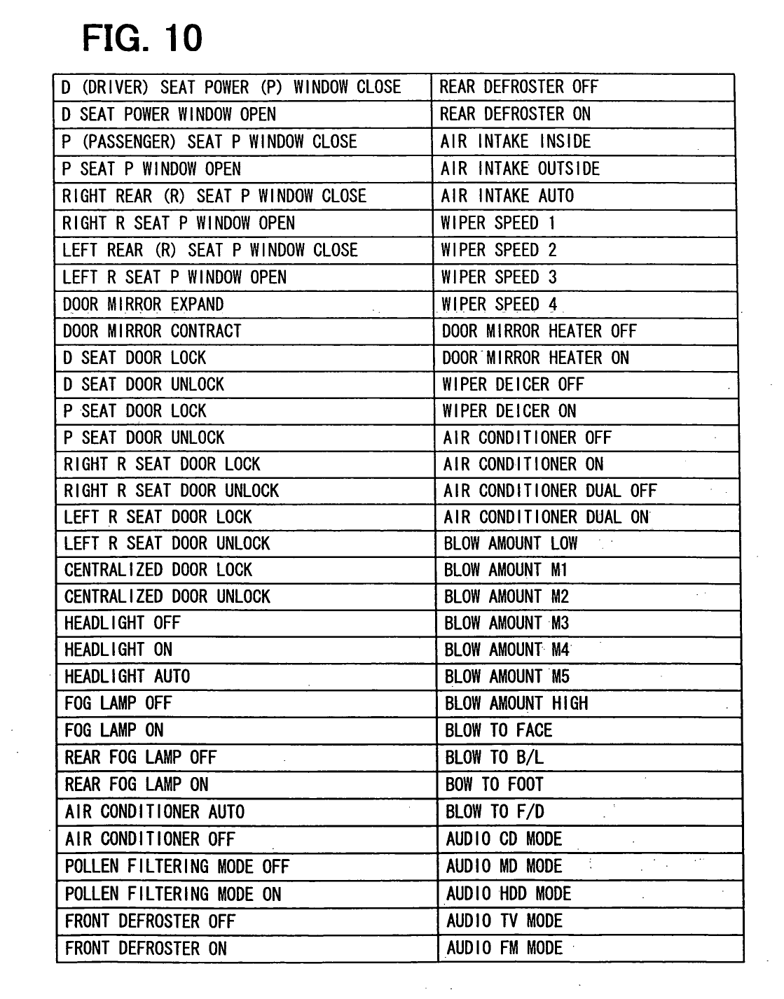

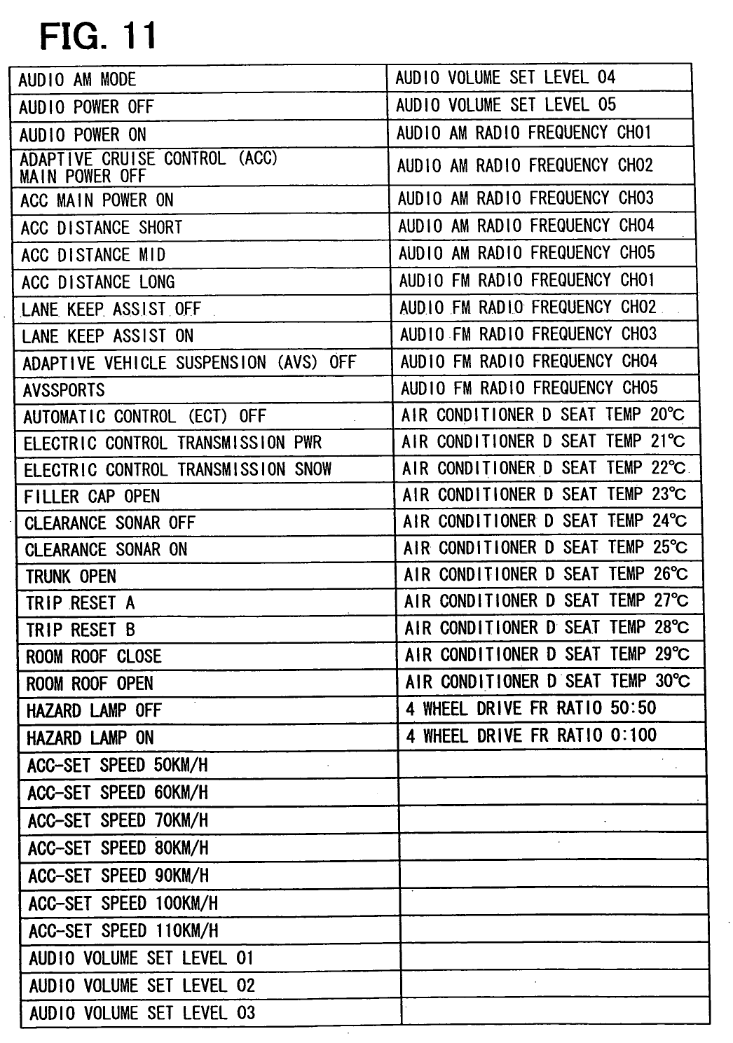

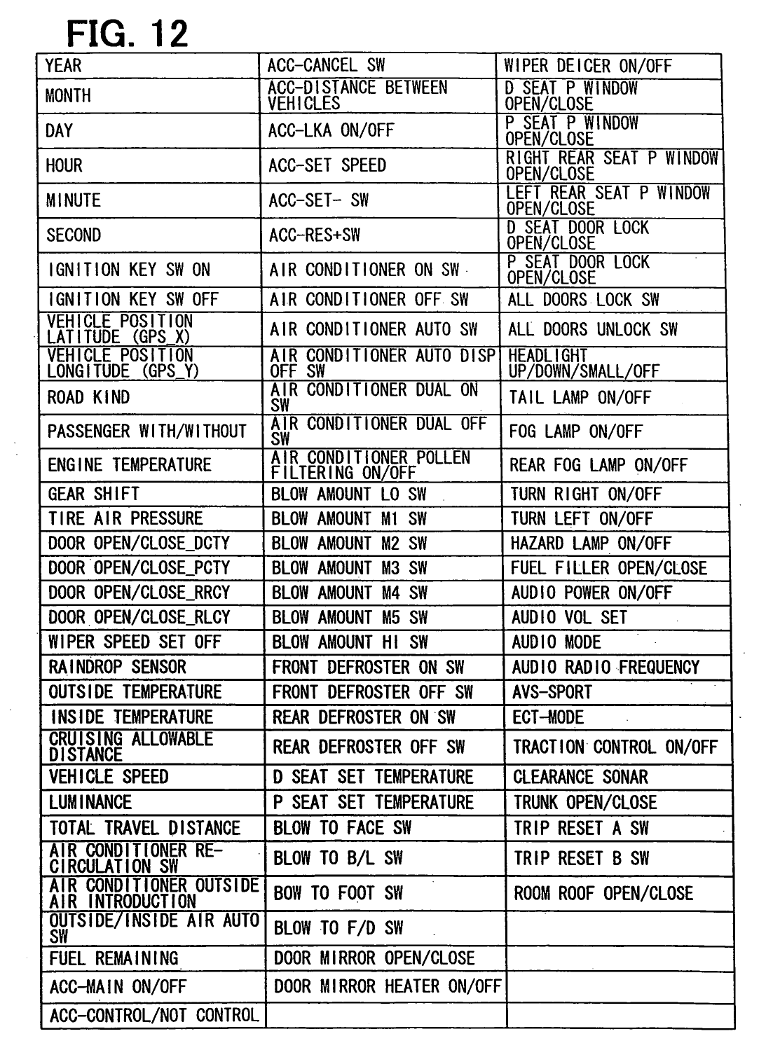

FIGS. 10 and 11 list example operations recommended by the control apparatus according to the embodiment of the present invention. FIG. 12 lists example sensor information available for determining recommended operations.

As mentioned above, various modifications may be made within the spirit and scope of the invention.

Each or any combination of processes, steps, or means explained in the above can be achieved as a software portion or unit (e.g., subroutine) and/or a hardware portion or unit (e.g., circuit or integrated circuit), including or not including a function of a related device; furthermore, the hardware portion or unit can be constructed inside of a microcomputer.

Furthermore, the software portion or unit or any combinations of multiple software portions or units can be included in a software program, which can be contained in a computer-readable storage media or can be downloaded and installed in a computer via a communications network.

Aspects of the disclosure described herein are set out in the following clauses.

As an aspect of the disclosure, a control apparatus for an onboard device is provided as follows. A recommended operation determination section is configured to use a first probability model to determine a second operation associated with a first operation performed for an onboard device. A user interface section is configured to display the second operation for an occupant and be supplied from the occupant with a response operation indicating whether to accept or reject the second operation. A control section is configured to perform the second operation on an onboard device when a response operation to accept the second operation is supplied via the user interface section.

When a driver performs an operation on any of onboard devices, the control apparatus estimates and presents an operation the driver is supposed to perform in association with that operation. When the driver simply performs an acceptance operation, the control apparatus performs the presented operation. It is possible to reduce a burden on the driver with operations of onboard devices.

As an optional aspect, a second probability model may be supplied with state information about a vehicle and output a probability of performing a recommended operation on an onboard device. The recommended operation determination section may use the second probability model to determine the recommended operation. The first operation may be an operation to accept or reject the recommended operation via the user interface section.

As an optional aspect, the control apparatus may further include a learning section that modifies the first probability model so as to increase a probability of selecting as the second operation an operation equal to a direct manual operation on an onboard device.

In the above, the learning section may modify the first probability model when a specified range contains a difference between a vehicle position corresponding to the direct manual operation on the onboard device and a vehicle position corresponding to input of the response operation. The learning section may modify the second probability model so as to increase a probability of selecting an operation equal to the direct manual operation as the recommended operation when the specified range does not contain the difference.

The above-mentioned state information about a vehicle includes not only information about the vehicle itself such as a vehicle speed and position but also information about situations around the vehicle and information about onboard device settings. The information about situations around the vehicle includes air conditioning information such as vehicle interior temperature, ambient temperature, current time, and the presence or absence of rain. The information about onboard device settings includes power on/off of an audio system, sound volume, and air conditioner temperature setting.

It will be obvious to those skilled in the art that various changes may be made in the above-described embodiments of the present invention. However, the scope of the present invention should be determined by the following claims.

What is claimed is:

1. A control apparatus for onboard devices in a vehicle, comprising:
a recommended operation determination section configured to determine, by using a first probability model, a second operation on an onboard device, the second operation being associated with a first operation, the first operation having been performed for an onboard device;
a user interface section configured to display the second operation for an occupant of the vehicle and be supplied from the occupant with a response operation indicating whether to accept or reject the second operation; and
a control section configured to perform the second operation on the onboard device when a response operation to accept the second operation is supplied via the user interface section.

2. The control apparatus according to claim 1,
wherein the recommended operation determination section determines a recommended operation on an onboard device using a second probability model, the second probability model being supplied with state information about the vehicle and outputting a probability of performing the recommended operation on the onboard device; and
wherein the first operation is to accept or reject the recommended operation via the user interface section.

3. The control apparatus according to claim 1, further comprising:
a learning section that modifies the first probability model so as to increase a probability of, when a direct manual operation on an onboard device has been performed, selecting as the second operation an operation equal to the direct manual operation on the onboard device.

4. The control apparatus according to claim 3,
wherein the learning section modifies the first probability model when a specified range contains a difference between a vehicle position corresponding to the direct manual operation on the onboard device and a vehicle position corresponding to input of the response operation; and
wherein the learning section modifies the second probability model so as to increase a probability of selecting an operation equal to the direct manual operation as the recommended operation when the specified range does not contain the difference.

5. A method for controlling onboard devices in a vehicle, the method comprising:
determining, by using a first probability model, a second operation on an onboard device, the second operation being associated with a first operation, the first operation having been performed for an onboard device;
displaying the second operation for an occupant in a user interface section;
receiving, from the occupant, a response operation indicating whether to accept or reject the second operation via the user interface section; and
performing the second operation on the onboard device when a response operation to accept the second operation is supplied via the user interface section.

6. The method according to claim 5, further comprising:
determining a recommended operation on an onboard device using a second probability model, the second probability model being supplied with state information about the vehicle and outputting a probability of performing the recommended operation on the onboard device,
wherein the first operation is to accept or reject the recommended operation via the user interface section.

7. The method according to claim 5, further comprising:
modifying the first probability model so as to increase a probability of selecting, when a direct manual operation has been performed for an onboard device, as the second operation an operation equal to the direct manual operation on the onboard device.

8. The method according to claim 7,
wherein when a specified range contains a difference between a vehicle position corresponding to the direct manual operation on the onboard device and a vehicle position corresponding to input of the response operation, the first probability model is modified; and
wherein when the specified range does not contain the difference, the second probability model is modified so as to increase a probability of selecting an operation equal to the direct manual operation as the recommended operation.
